(19) United States
(12) Patent Application Publication
(10) Pub. No.: US 2025/0298120 A1
(43) Pub. Date: Sep. 25, 2025

(54) TIME DIVISION MULTIPLE ACCESS (TDMA) MULTI-RADAR CO-EXISTENCE WITH GROUP-BASED RESOURCE ALLOCATION

(71) Applicant: QUALCOMM Incorporated, San Diego, CA (US)

(72) Inventors: Stelios STEFANATOS, San Diego, CA (US); Kapil GULATI, Belle Mead, NJ (US); Gene Wesley MARSH, San Diego, CA (US); Junyi LI, Greentown, PA (US); Arthur GUBESKYS, San Diego, CA (US); Preeti KUMARI, San Diego, CA (US)

(21) Appl. No.: 18/860,512

(22) PCT Filed: Jun. 13, 2023
(86) PCT No.: PCT/US2023/025169

§ 371 Date: Oct. 25, 2024

(30) Foreign Application Priority Data
Jun. 27, 2022 (GR) 20220100516

(51) Int. Cl. G01S 7/02; G01S 7/00; G01S 13/34

(52) U.S. Cl. CPC G01S 7/0235; G01S 7/006; G01S 13/343

(57) ABSTRACT

Certain aspects of the present disclosure provide a method for wireless communications by a first apparatus. The first apparatus identifies a first set of slots configured for a first group of apparatuses including the first apparatus. The first apparatus transmits, according to a first time delay offset relative to a previous frame, a chirp transmission in a first frame during a first slot within the first set of slots. The first apparatus transmits a chirp transmission in a second frame during a second slot within the first set of slots, according to a second time delay offset after the first frame. The second time delay offset is different from the first time delay offset.

### CROSS-REFERENCE TO RELATED APPLICATION(S)

This application claims priority to Greece Patent Application Serial No. 20220100516 filed Jun. 27, 2022, which is hereby incorporated by reference herein.

### FIELD OF THE DISCLOSURE

Aspects of the present disclosure relate to wireless communications, and more particularly, to techniques allocating resources in scenarios with multiple radar devices to help avoid interference.

### Introduction

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for by a first apparatus, comprising: identifying a first set of slots configured for a first group of apparatuses including the first apparatus; transmitting, according to a first time delay offset relative to a previous frame, a chirp transmission in a first frame during a first slot within the first set of slots; and transmitting a chirp transmission in a second frame during a second slot within the first set of slots, according to a second time delay offset after the first frame, wherein the second time delay offset is different from the first time delay offset.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIGS. 5A-5B show diagrammatic representations of example vehicle-to-everything (V2X) systems.

FIG. 6A illustrates a vehicle using a radar device to detect target objects in an environment.

FIG. 6B illustrates example time and frequency plot showing transmission of signals and reception of reflected signals via a radar device of a vehicle.

FIG. 7 illustrates example environment in which interfering signals are produced by multiple radar devices of vehicles operating in the environment.

FIG. 8 illustrates example time and frequency plot showing chirp transmissions of a frame via multiple radar devices of vehicles at different time grid points.

FIG. 9 is a flow diagram illustrating example operations for wireless communications by a first apparatus.

FIG. 10 is a call flow diagram illustrating example operations between vehicles operating in an environment.

FIG. 11 illustrates example time and frequency plot showing time partitioned into multiple slots separated by guard intervals.

FIG. 12 illustrates example time and frequency plot showing chirp transmissions via multiple radar devices of vehicles within different slots.

FIG. 13 illustrates example grouping of radar devices of vehicles.

FIG. 14 illustrates example time and frequency plot showing chirp transmissions via multiple radar devices of vehicles within different slots based on a time delay offset.

FIG. 15 illustrates example first set of slots for first group of vehicles and second set of slots for second group of vehicles.

FIG. 16 illustrates a communications device that may include various components configured to perform operations for the techniques disclosed herein.

### DETAILED DESCRIPTION

Aspects of the present disclosure provide apparatuses, methods, processing systems, and computer readable mediums for allocating resources to multiple radar devices to avoid interference. In some cases, a time division multiple access (TDMA)-based multi-radar co-existence scheme may use group-based resource allocation to help avoid intra-group interference elimination.

TDMA-based techniques may be implemented to avoid interference completely. In some cases, the TDMA-based techniques are able to eliminate ghost targets completely as long as all radar devices operating within an environment utilize orthogonal resources. To enable the TDMA-based techniques, the radar devices may need to reserve their resources via signaling, which, however, becomes inefficient when there is a high density of the radar devices (e.g., due to some signaling overhead).

Aspects of the present disclosure provide a modification of TDMA-based techniques, by using a flexible type of orthogonal resources and a time-offset based system, which results in reducing or eliminating interference even between radar devices that select same resources. The techniques described herein may preconfigure assignment of the radar devices into different groups. This may avoid a need for signaling corresponding to resource reservation to the radar devices. In some aspects, these groups are naturally formed based on location and movement attributes of the radar devices (e.g., the radar devices mounted on vehicles moving in a same direction in a freeway form a group). The radar devices may use same frequency-modulated continuous wave (FMCW) parameters (which may be preconfigured or indicated by a network entity) and have a common time reference (e.g., a global positioning system (GPS)).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

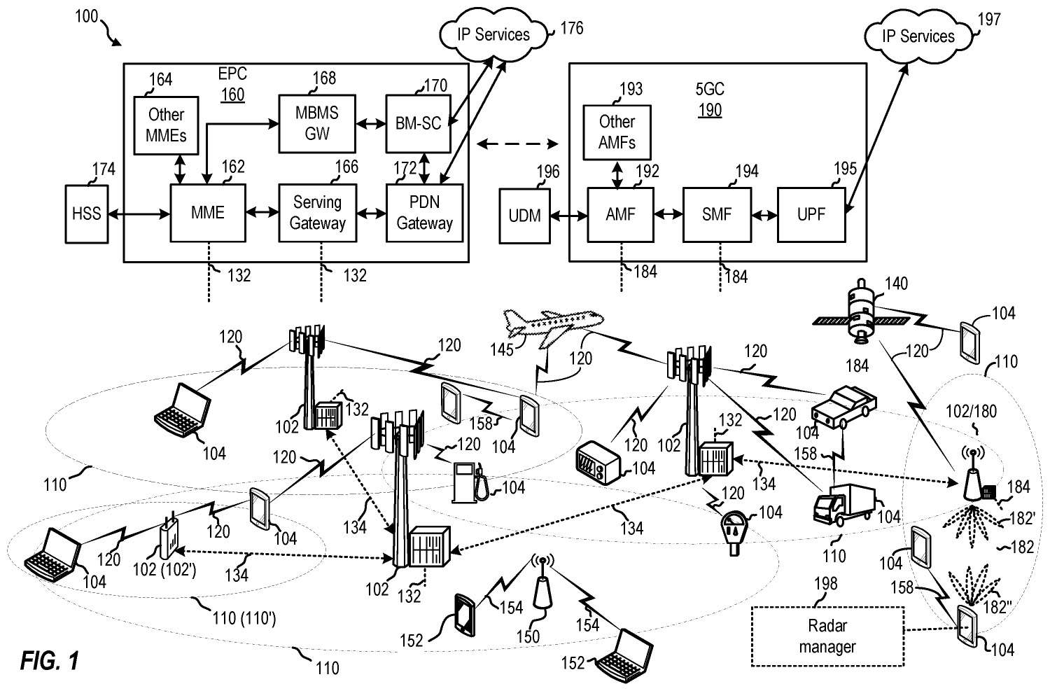

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

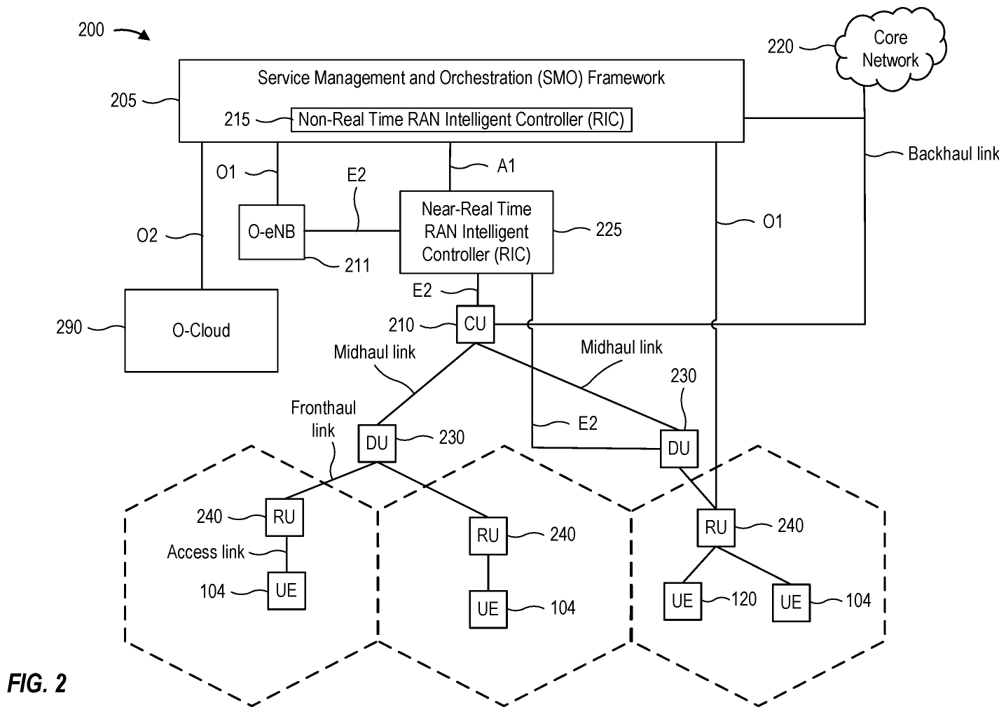

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5GNR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

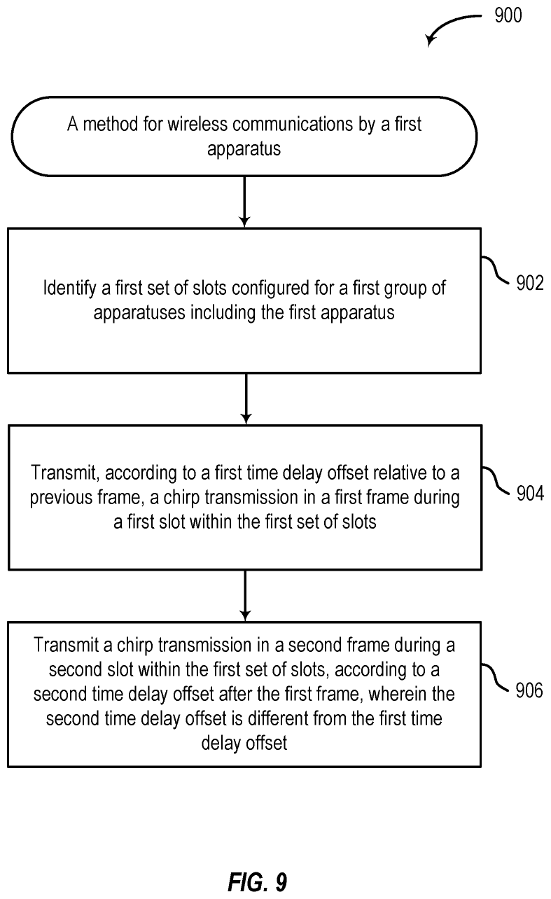

Wireless communication network 100 further includes radar manager component 198, which may be configured to perform operations 900 of FIG. 9.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

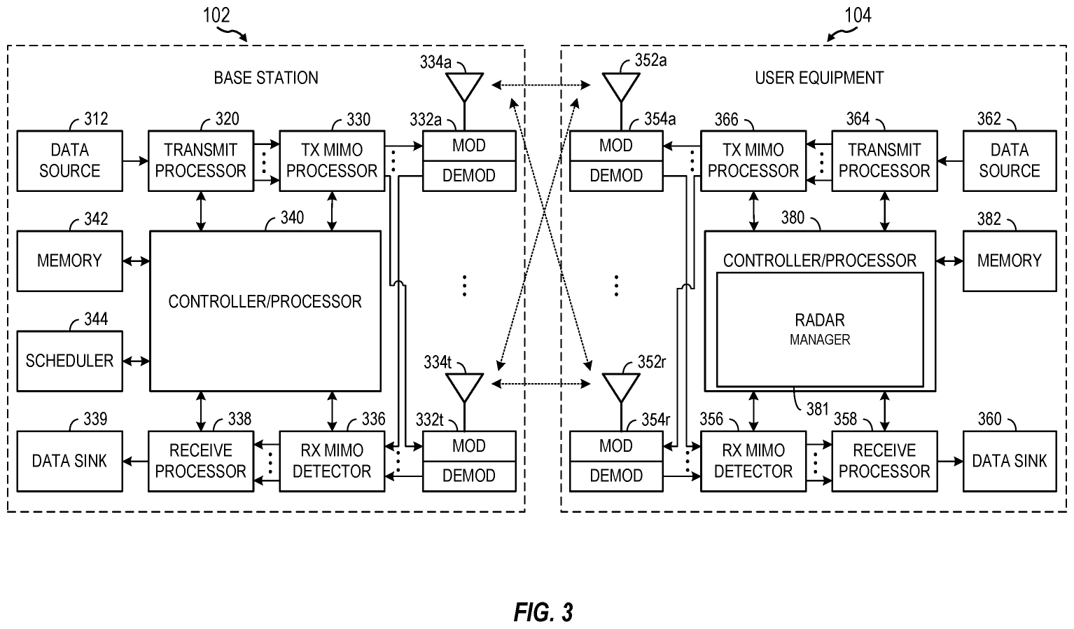

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes radar manager component 381, which may be representative of radar manager component 198 of FIG. 1. Notably, while depicted as an aspect of controller/processor 380, radar manager component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

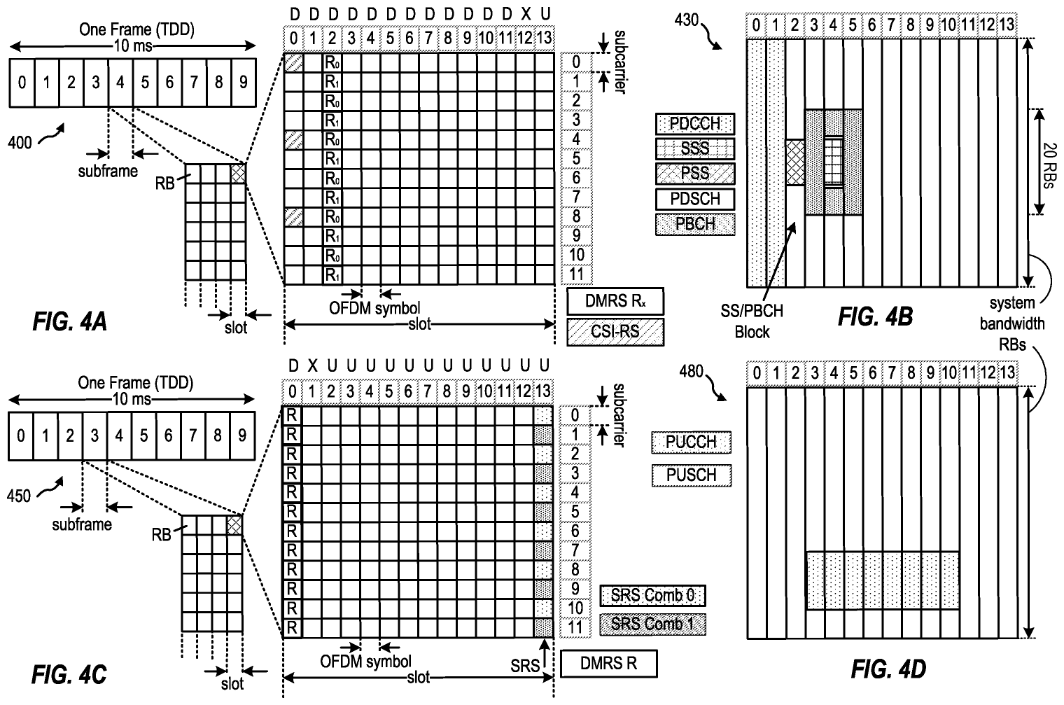

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Sidelink Communications

User equipments (UEs) (e.g., vehicles) communicate with each other using sidelink signals. Real-world applications of sidelink communications may include UE-to-network relaying, vehicle-to-vehicle (V2V) communications, vehicle-to-everything (V2X) communications, Internet of Everything (IoE) communications, IoT communications, mission-critical mesh, and/or various other suitable applications.

A sidelink signal refers to a signal communicated from one UE to another UE without relaying that communication through a scheduling entity (e.g., UE or a network entity), even though the scheduling entity may be utilized for scheduling and/or control purposes. In some examples, the sidelink signal is communicated using a licensed spectrum (unlike wireless local area networks, which typically use an unlicensed spectrum). One example of sidelink communication is PC5, for example, as used in V2V, long term evolution (LTE), and/or new radio (NR).

Various sidelink channels are used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal UEs to discover each other. The PSCCH may carry control signaling such as sidelink resource configurations, resource reservations, and other parameters used for data transmissions. The PSSCH may carry the data transmissions. The PSFCH may carry feedback such as acknowledgement (ACK) and/or negative ACK (NACK) information corresponding to transmissions on the PSSCH.

In some NR systems, a two stage sidelink control information (SCI) is supported. The two stage SCI may include a first stage SCI (e.g., SCI-1) and a second stage SCI (e.g., SCI-2). SCI-1 may include resource reservation and allocation information. SCI-2 may include information that can be used to decode data and to determine whether a UE is an intended recipient of a transmission. SCI-1 and/or SCI-2 may be transmitted over a PSCCH.

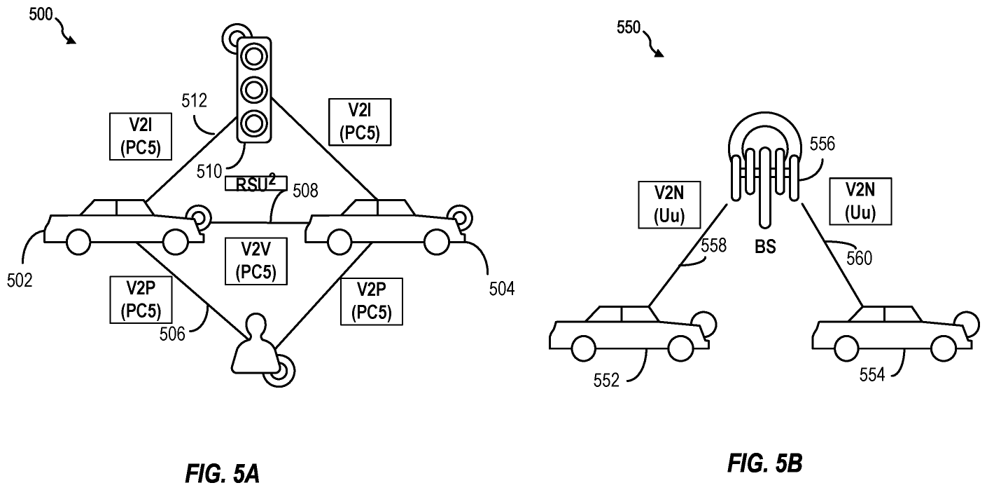

FIG. 5A and FIG. 5B show diagrammatic representations of example V2X systems. For example, vehicles shown in FIG. 5A and FIG. 5B may communicate via sidelink channels and relay sidelink transmissions. V2X is a vehicular technology system that enables vehicles to communicate with traffic and an environment around them using short-range wireless signals, known as sidelink signals.

The V2X systems shown in FIG. 5A and FIG. 5B provide two complementary transmission modes. A first transmission mode, shown by way of example in FIG. 5A, involves direct communications (for example, also referred to as sidelink communications) between participants in proximity to one another in a local area. A second transmission mode, shown by way of example in FIG. 5B, involves network communications through a network, which may be implemented over a Uu interface (for example, a wireless communication interface between a radio access network (RAN) and a UE).

Referring to FIG. 5A, a V2X system 500 (for example, including V2V communications) is illustrated with two vehicles 502, 504. A first transmission mode allows for direct communication between different participants in a given geographic location. As illustrated, a vehicle 502 can have a wireless communication link 506 with an individual through a PC5 interface. Communications between the vehicles 502 and 504 may also occur through a PC5 interface 508. In a like manner, communication may occur from the vehicle 502 to other highway components (for example, roadside unit (RSU) 510), such as a traffic signal or sign through a PC5 interface 512. With respect to each communication link illustrated in FIG. 5A, two-way communication may take place between devices, therefore each device may be a transmitter and a receiver of information. The V2X system 500 may be a self-managed system implemented without assistance from a network entity. A self-managed system may enable improved spectral efficiency, reduced cost, and increased reliability as network service interruptions do not occur during handover operations for moving vehicles. The V2X system 500 may be configured to operate in a licensed or unlicensed spectrum, thus any vehicle with an equipped system may access a common frequency and share information. Such harmonized/common spectrum operations allow for safe and reliable operation.

FIG. 5B shows a V2X system 550 for communication between a vehicle 552 and a vehicle 554 through a network entity 556. Network communications may occur through discrete nodes, such as a network entity 556 that sends and receives information to and from (for example, relays information between) the vehicles 552, 554. The network communications through vehicle to network (V2N) links 558 and 560 may be used, for example, for long-range communications between the vehicles 552, 554, such as for communicating the presence of a car accident a distance ahead along a road or highway. Other types of communications may be sent by a wireless node to the vehicles 552, 554, such as traffic flow conditions, road hazard warnings, environmental/weather reports, and service station availability, among other examples. Such data can be obtained from cloud-based sharing services.

### Example Radar Device Operation and Interference in Multi-Radar Coexistence

User equipments (UEs) (e.g., the vehicles 502, 504, 552, and 554 in FIG. 5A and FIG. 5B) are equipped with sensors (e.g., radar devices) that allow these vehicles to better perceive an environment (e.g., driving on a road) in which the vehicles operate. For example, a radar device may allow a particular vehicle to sense target objects (e.g., road obstacles, other vehicles, etc.) in the environment, and thereby enhancing situational awareness when operating in the environment. Sensing these target objects within the environment may help the vehicle to improve driving decisions and maneuvers.

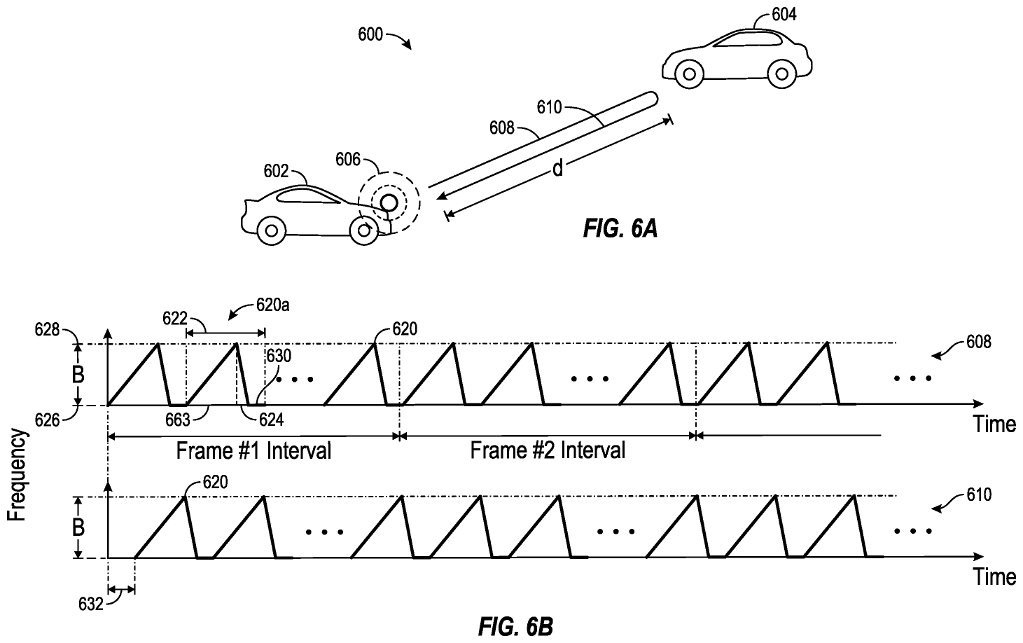

FIG. 6A illustrates using a radar device to detect target objects in an environment 600. As illustrated, the environment 600 includes a first vehicle 602 and a second vehicle 604. In some cases, the first vehicle 602 may be an example of any one of the vehicles 502, 504, 552, or 554 illustrated in FIG. 5A and FIG. 5B. Additionally, in some cases, the first vehicle 602 may incorporate or be an example of the UE 104 illustrated in FIG. 1.

The first vehicle 602 includes a radar device that is configured to emit/transmit signals 606 to detect target objects in the environment 6500. The signals 606 may include frequency-modulated continuous wave (FMCW) signals, known as chirp transmissions, and may be generated based on a set of parameters. In some cases, the signals 606 may be transmitted in a gigahertz (GHz) frequency range (e.g., 24 GHz, 35 GHz, 76.5 GHz, 79 GHz, etc.) in one or more transmission frames. As shown in FIG. 6A, the signals 606 may include one or more signals 608, which are emitted by the radar device of the first vehicle 602. Thereafter, when a target object, such as the second vehicle 604, is present in the environment 600, the one or more signals 608 may be reflected off of the second vehicle 604 and may be received by the radar device of the first vehicle 602 after a certain propagation delay (τ).

This propagation delay may be represented as follows: τ=2d/c, where d is a distance between the first vehicle 602 and the second vehicle 604 and c is the speed of light. Because the speed of light (c) is constant, the first vehicle 602 is able to determine the distance (d) of the second vehicle 604 relative to a position of the first vehicle 602 based on the propagation delay (τ) between when the one or more signals 608 are emitted by the radar device of the first vehicle 602 and when one or more reflected signals 610 (e.g., reflections of the one or more signals 608) are received by the radar device of the first vehicle 602. In other words, the first vehicle 602 may determine the distance (d) of the second vehicle 604 by emitting the one or more signals 608 and measuring the time it takes for the one or more reflected signals 610 to be received by the radar device of the first vehicle 602.

FIG. 6B shows a time and frequency plot illustrating transmission of signals and reception of reflected signals, such as the one or more signals 608 and the one or more reflected signals 610, by the radar device of the first vehicle 602. As shown, the radar device of the first vehicle 602 is configured to transmit (e.g., emit) the one or more signals 608. The one or more signals 608 are transmitted in a plurality of frames defined as a particular interval in time, such as frame interval #1, frame interval #2, etc.

The one or more signals 608 within each frame interval may include a plurality of chirp transmissions 620 associated with a particular carrier frequency. A number of chirp transmissions within each frame interval may be the same. Each chirp transmission may have a total duration 622 consisting of a frequency ramp up duration 623 and a frequency ramp down duration 624. The frequency ramp up duration 623 includes a period of time in which a transmission frequency of a chirp 620a of the plurality of chirp transmissions 620 is increased from an initial transmission frequency 626 to a maximum transmission frequency 628. A difference between the initial transmission frequency 626 and the maximum transmission frequency 628 represents a bandwidth (B) or frequency sweep of the chirp transmission 620a. Similarly, the frequency ramp down duration 624 includes a period of time in which the transmission frequency of the chirp transmission 620a is decreased from the maximum transmission frequency 628 to the initial transmission frequency 626. Following the chirp transmission 620a there may be a duration 630 representing an inactive period occurring prior to the transmission of a subsequent chirp of the plurality of chirp transmissions 620.

As noted above, after the one or more signals 608 are transmitted by the first vehicle 602, the one or more signals 608 may be reflected off of the second vehicle 604 and received by the radar device of the first vehicle 602 as the one or more reflected signals 610. As shown in FIG. 6B, the one or more reflected signals 610 include the one or more chirp transmissions 620 of the one or more signals 608, which may be received by the radar device of the first vehicle after a propagation delay (τ) 632 after being transmitted in the one or more signals 608.

Based on the propagation delay 632 associated with the one or more reflected signals 610, the radar device of the first vehicle 602 may determine the distance of the second vehicle 604 according to

$$\frac{c τ}{2} ,$$

where τ is the propagation delay and c is the speed of light. The radar device of the first vehicle 602 may also be able to determine a relative radial velocity and a direction (e.g., if equipped with multiple receive (RX) antennas) in a similar manner.

This procedure of transmitting/emitting the one or more signals 608 and receiving the one or more reflected signals 610 may be repeated by the radar device of the first vehicle 602 over multiple successive frames. Each frame will result in a number of “detections”, one for each target object in the environment 600, and indicate the target object distance/velocity/direction at the time the frame was transmitted. The radar device of the first vehicle 602 may then combine the detections in the successive frames, resulting in a time series of detections of the target objects that are input to a data-association and track-detection filter. In case of a single target object, the task of the data-association and track-detection filter is to smooth out the detections of the target object (e.g., from noise impairments) and create a “clean” trajectory (or track) of the target object in the environment 600. In case of multiple target objects, the task of the data-association and track-detection filter is to assign the detections of each frame to distinct target objects and using previous target object detections create the trajectories of all the target objects present in the environment 600. The data-association and track-detection filter is also responsible for detecting and tracking new target objects within the environment 600 as well as “dropping” target objects that cannot be associated to any track or that are not associated with any new detections (e.g., the target objects that have left the environment 600).

However, while radar devices generally improve situational awareness in an environment, such as the environment 600, the operation of many radar devices in the environment, associated with different vehicles, may negatively impact the accuracy to sense target objects within the environment. For example, multiple radar devices operating in the same environment (and transmitting in overlapping time and frequency resources) may produce interfering signals. These interfering signals may create “ghost” targets (e.g., targets that do not actually exist in a detected location, also known as “false alarms”) and/or result in an increase of a noise floor, which impacts detectability of (actual) target objects within the environment.

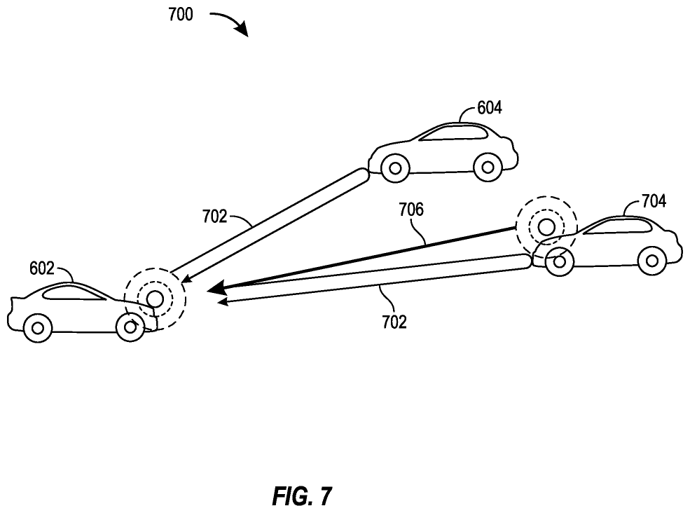

FIG. 7 illustrates an environment 700 in which interfering signals are produced by multiple radar devices operating in the environment 700. For example, as illustrated in FIG. 7, the environment 700 again includes the first vehicle 602 and the second vehicle 604. The first vehicle 602 may transmit one or more signals 702 via a radar device in the environment 700 for detecting and tracking target objects within the environment 700.

The environment 700 includes a third vehicle 704, which may include a radar device configured to transmit signals for detecting and tracing target objects within the environment 700. In some cases, when radars devices, such as the radar device of the first vehicle 602 and the radar device of the third vehicle 704, operate over a same frequency, signals from these radar devices may interfere with each other. For example, as shown, in addition to the radar device of the first vehicle 602 transmitting the one or more signals 702 and receiving corresponding reflections, the radar device of the first vehicle 602 may also receive a direct signal 706 from the radar device of the third vehicle 704.

The direct signal 706 received from the radar device of the third vehicle 704 may increase a noise floor associated with the radar device of the first vehicle 602, rendering target object detection by the radar device of the first vehicle 602 less reliable. Additionally, in some cases, the direct signal 706 received from the radar device of the third vehicle 704 may result in the radar device of the first vehicle 602 detecting ghost targets. The ghost targets may increase tracking complexity associated with a data-association and track-detection filter of the radar devices, and even have a potential to cause autonomous driving applications to malfunction, which can lead to catastrophic events.

In some cases, to reduce or eliminate interference in an environment in which multiple radar devices associated with different vehicles operate, techniques are implemented that may involve coordinating waveform parameters and frame delays between the radar devices. For example, the techniques may include having the radar devices use a common transmission configuration when generating and transmitting signals such that all the radar devices within the environment generate and transmit identical signals.

By having the radar devices operating in the environment transmit identical signals, any interference caused between signals in the environment may result only in the creation of ghost targets at a victim radar device (e.g., a radar device receiving interfering signals). However, because the radar devices within the environment transmit an identical signal, a noise level increase within the environment (e.g., which is a main cause of misdetecting actual target objects in the environment) is eliminated or at least significantly reduced as compared to when multiple radar devices operate in the environment without using identical signals.

Further, due to the fact that a primary interference experience in the environment is the creation of ghost targets once the common transmission configuration is applied by the radar devices in the environment, techniques may be implemented to assist radar devices to more-easily discard or ignore these ghost targets. Such techniques may involve introducing varying or changing time delays between frames in which signals are transmitted by the radar devices. For example, changing or varying the time delays between frames in which the signals are transmitted by a radar device of a first vehicle may make it appear (e.g., to a second vehicle) as if the first vehicle is a ghost target that is moving in an unrealistic manner (e.g., traveling hundreds of meters in a manner of millisecond or the like), provided that the varying time delays are sufficiently different from those used by the second vehicle. Accordingly, the second vehicle may observe these unrealistic movements and discard or ignore ghost targets detected across frames due to signals transmitted by the radar device of the first vehicle. In other words, interference caused by the first vehicle's radar device may be readily removed by a radar device of second vehicle because the radar device of the first vehicle is making it appear as if the first vehicle is moving in an unrealistic manner, causing the radar device of the second vehicle to believe that the first vehicle is a ghost target that can be readily discarded or ignored.

### Example Multi-Radar Coordinated Interference

As noted above, in a vehicle-to-everything (V2X) system, vehicles operating within an environment may include radar devices to sense target objects (e.g., road obstacles, other vehicles, etc.) in the environment. Sensing such target objects may enhance situational awareness (e.g., allowing a vehicle to improve driving decisions and maneuvers).

In some cases, simultaneous operation of multiple radar devices may negatively impact an accuracy to sense target objects within an environment. For example, multiple radar devices operating in a same environment may produce interfering signals, which may create “ghost” targets and/or result in an increase of a noise floor, which impacts detectability of (actual) target objects within the environment. The increase in the noise floor (or broadband noise) within the environment is a main cause of misdetecting target objects. Further, the ghost targets may increase tracking complexity of the radar devices and even have a potential to cause autonomous driving applications to malfunction, which can lead to catastrophic events. The tracking complexity of the radar devices may be increased because the radar devices have to differentiate between actual and ghost targets (and then discard the ghost targets), which is not always possible.

Various signal processing techniques are implemented to either discard observed signal samples contaminated by multi-radar interference altogether, or identify a portion of a received energy corrupted/contaminated by the multi-radar interference and then cancel it out (e.g., multi-radar interference cancelation). However, when there is substantial interference, a sample-discarding technique may not work (e.g., because there is a high probability all signal samples may be contaminated by the multi-radar interference). The signal processing techniques may also not work (e.g., for reducing or eliminating multi-radar interference) since the signal processing techniques are computationally heavy and have only been tested with a limited number of interferers/interfering vehicles (e.g., only one interfering vehicle having a radar device).

In some systems, multiple radar devices associated with different vehicles operating within an environment may generate chirp transmissions, based on a same set of frequency-modulated continuous wave (FMCW) parameters, to reduce or eliminate multi-radar interference in the environment. The operation of these vehicles may lead to a, so called, coordinated interference. In some cases, the coordinated interference may result in generating ghost detections at a victim vehicle/radar device. Such ghost detections may be treated as originating from ghost targets that the victim vehicle cannot differentiate from an actual target object. In order to prevent such ghost detections, some level of coordination may be needed between the vehicles (e.g., with respect to channel access).

In general, ghost targets are generated when a chirp transmission of an interferer vehicle is initiated at a time sufficiently close to a time a chirp transmission of a victim vehicle is initiated. Accordingly, to prevent vehicles operating in a same environment from producing interfering signals that may create ghost targets, a time division multiple access (TDMA)-based technique is implemented. Per this technique, chirp transmissions from the vehicles start only at specific time instances and the vehicles reserve these time instances (e.g., via signaling).

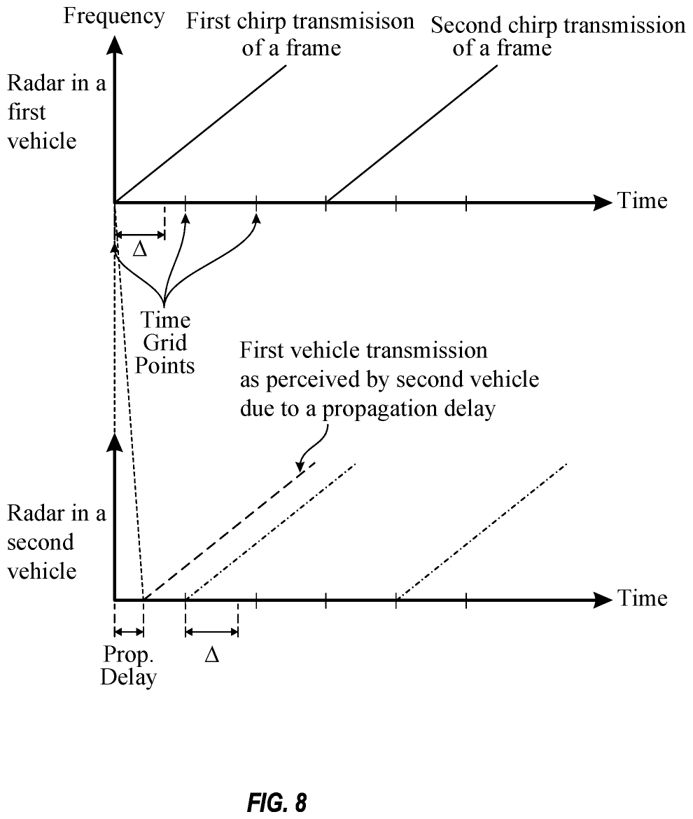

For example, as illustrated in FIG. 8, a first vehicle and a second vehicle align their chirp transmission times to coincide with points from a pre-configured grid of points in time. Per TDMA-based technique, a periodicity of these time grid points is an integer divisor of chirp transmission and frame periods.

During operation, the first vehicle creates a ghost target at the second vehicle, if a chirp transmission of the first vehicle, taking into account a propagation delay between the first vehicle and the second vehicle, appears at the second vehicle sufficiently close (earlier or later) with respect to a start of a chirp transmission of the second vehicle. When this time difference is greater than a threshold, the chirp transmission of the first vehicle has no impact on the second vehicle, even when the chirp transmission of the first vehicle partially overlaps with the chirp transmission of the second vehicle. The threshold may depend on common parameters (e.g., FMCW parameters) associated with the first vehicle and the second vehicle.

In some cases, the time grid points are selected such that two successive time grid points are separated by at least a maximum expected propagation delay (A) between two interfering vehicles (e.g., the first vehicle and the second vehicle). The timing inaccuracies may also be considered in setting up a time grid point separation. In such cases, no ghost targets will appear at any vehicle as long as the first vehicle and the second vehicle do not start their chirp transmissions at same time grid points.

In some cases, orthogonality among the first vehicle and the second vehicle transmitting their chirp transmissions on different time grid points apply for all chirp transmissions in their frames, since the chirp transmissions are transmitted periodically. Accordingly, the chirp transmissions will always be transmitted on different time grid points.

Although this technique of transmitting chirp transmissions over different time grid points may reduce or eliminate interference, the first vehicle and the second vehicle need to first coordinate so that the first vehicle and the second vehicle do not select same time grid points. This will generally be a high probability event, when the first vehicle and the second vehicle select the time grid points independently (and there may be high vehicle density).

In some cases, the first vehicle and the second vehicle, prior to their respective frame start, reserve time grid points over which chirp transmissions of a frame will be transmitted. The reservation of the time grid points may be achieved by a listen before talk (LBT) mechanism and/or broadcast signaling.

In some cases, the technique of transmitting chirp transmissions over different time grid points, to reduce or eliminate interference, may become inefficient. For example, where there is a high vehicle density, this technique does not guarantee a collision free operation. Also, this technique may pollute a communication channel between multiple vehicles with a signaling overhead required for reserving the time grid points. Furthermore, this technique may introduce large inactivity duration due to LBT blocking.

Accordingly, a different technique is needed so that TDMA-based radar device operation is achieved with minimal signaling and minimum multi-radar interference.

### Aspects Related to TDMA Multi-Radar Co-Existence with Group-Based Resource Allocation and Intra-Group Interference Elimination

Aspects of the present disclosure provide apparatuses, methods, processing systems, and computer readable mediums for time division multiple access (TDMA)-based multi-radar co-existence with group-based resource allocation and intra-group interference elimination.

For example, techniques described herein may use a flexible type of orthogonal resources and a time-offset based system, which results in reducing or eliminating interference even between radar devices that select same resources. The techniques described herein may preconfigure assignment of the radar devices into different groups having preconfigured assignment of orthogonal resources. This may avoid a need for signaling corresponding to resource reservation to the radar devices. In some aspects, the groups are naturally formed based on location and movement attributes of the radar devices (e.g., the radar devices mounted on vehicles moving in a same direction in a freeway form a group). The radar devices may use same frequency-modulated continuous wave (FMCW) parameters (which may be preconfigured or indicated by a network entity) and have a common time reference (e.g., a global positioning system (GPS)).

The techniques described herein may partition time into slots of non-trivial duration. The successive slots are separated by guard intervals. A chirp transmission from a radar device can start anytime within a slot. This is different from a system where a start of the chirp transmission occurs only over points of a grid. In some cases, the slots are designed and configured such that chirp transmissions from different radar devices starting over different slots do not interfere with each other (even if these chirp transmissions partially overlap).

The techniques described herein may partition radar devices into groups. Each group is preconfigured with an exclusive set of slots. This may help to eliminate inter-group interference between the radar devices belonging to different groups. Furthermore, to prevent intra-group interference, the radar devices of the same group (that use same slots) do not transmit their frames using a fixed period. For example, a time offset may be applied to a start of every frame (and a chirp period within a frame remains fixed over all frames), so that intra-group ghost targets appear as hoping in space among consecutive frames (and naturally discarded by association/tracking filters of the radar devices as false alarms). The time offset may be a positive time offset or a negative time offset.

FIG. 9 illustrates example operations 900 for wireless communication. The operations 900 may be performed, for example, by a first apparatus (e.g., such as UE 104 in wireless communication network 100 of FIG. 1). The operations 900 may be implemented as software components that are executed and run on one or more processors (e.g., controller/processor 380 of FIG. 3). Further, transmission and reception of signals by the first apparatus in the operations 900 may be enabled, for example, by one or more antennas (e.g., antennas 352 of FIG. 3). In certain aspects, the transmission and/or reception of signals by the first apparatus may be implemented via a bus interface of one or more processors (e.g., the controller/processor 380) obtaining and/or outputting signals.

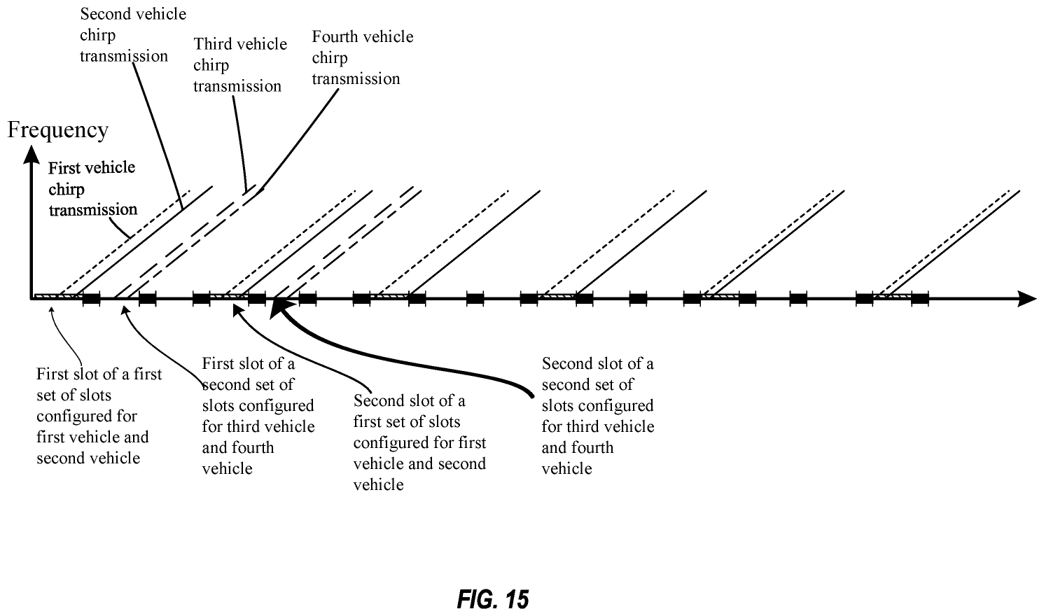

The operations 900 begin, at 902, by identifying a first set of slots configured for a first group of apparatuses including the first apparatus. For example, the first apparatus may identify the set of slots, using a processor of UE 104 shown in FIG. 1 or FIG. 3 and/or of the apparatus shown in FIG. 15.

At 904, the first apparatus transmits, according to a first time delay offset relative to a previous frame, a chirp transmission in a first frame during a first slot within the first set of slots. For example, the first apparatus may transmit the chirp transmission in the first frame, using antenna(s) and/or transmitter/transceiver components of UE 104 shown in FIG. 1 or FIG. 3 and/or of the apparatus shown in FIG. 15.

At 906, the first apparatus transmits a chirp transmission in a second frame during a second slot within the first set of slots, according to a second time delay offset after the first frame. The second time delay offset is different from the first time delay offset. For example, the first apparatus may transmit the chirp transmission in the second frame, using antenna(s) and/or transmitter/transceiver components of UE 104 shown in FIG. 1 or FIG. 3 and/or of the apparatus shown in FIG. 15.

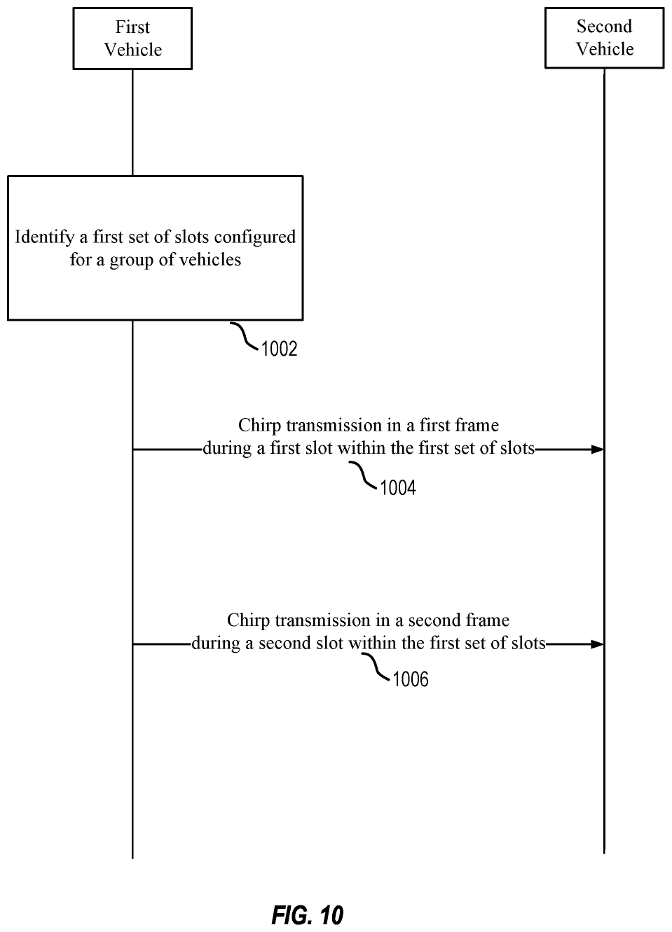

The operations shown in FIG. 9 may be understood with reference to FIGS. 10-14.

As illustrated in FIG. 10, at 1002, a first apparatus (e.g., a first vehicle) identifies a first set of slots preconfigured for the first vehicle and a second vehicle. For example, the first vehicle and/or the second vehicle (which may be part of a same first group of vehicles) are assigned the first set of slots to accommodate periodic chirp transmissions with one or multiple frames.

In certain aspects, the first vehicle may receive an indication indicating its group (e.g., the first group) and a first set of slots allocated for the first group. In one example, the first vehicle may receive the indication from a network entity. In another example, the first vehicle may receive the indication from a road size unit (RSU).

In certain aspects, the first vehicle and the second vehicle are associated with a common time reference (e.g., a GPS). In certain aspects, the first vehicle and the second vehicle are associated with a same set of FMCW parameters. The FMCW parameters may include a bandwidth, a carrier frequency, a chirp transmission duration, upchirp intervals, downchirp intervals, a number of chirp transmissions per frame, a chirp transmission period within a frame, a frame period, and/or a sampling frequency.

At 1004, the first vehicle transmits a chirp transmission in a first frame, during a first slot within the first set of slots, according to a first time delay offset after a previous frame. The first time delay offset may be randomly selected. In one example, the first time delay offset is a positive time delay offset. In another example, the first time delay offset is a negative time delay offset. The positive/negative time delay offset is such that a start of a new frame occurs within a same slot as if no delay was applied (e.g., because otherwise a chirp transmission would occur over slots not assigned to the group).

At 1006, the first vehicle transmits a chirp transmission in a second frame, during a second slot within the first set of slots, according to a second time delay offset after the first frame. The second time delay offset may be randomly selected. The second time delay offset may be different from the first time delay offset. In one example, the second time delay offset is a positive time delay offset. In another example, the second time delay offset is a negative time delay offset.

In certain aspects, the first time delay offset and the second time delay offset are restricted so one or more chirp transmissions of the first frame and the second frame fall within allocated slots within the first set of slots.

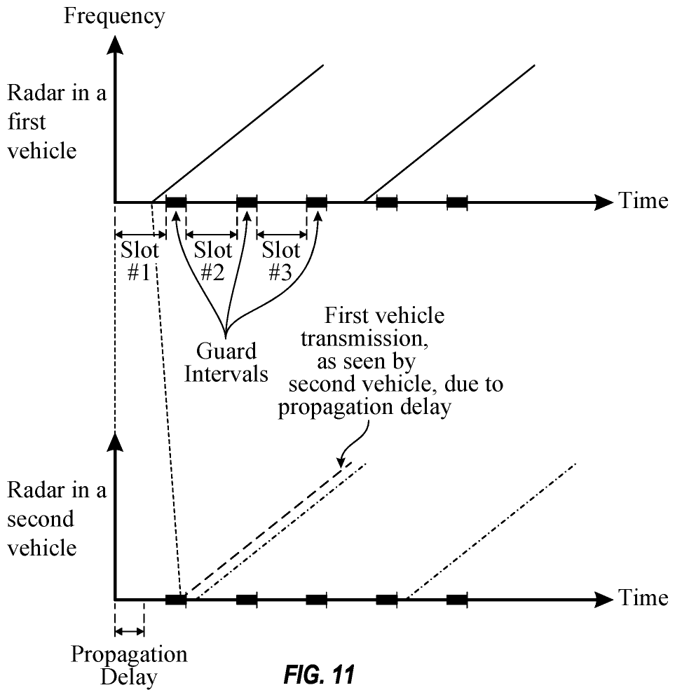

As illustrated in FIG. 11, time is partitioned into a first set of slots (e.g., assigned for a group of vehicles). In other words, the first set of slots represent partitions of the time. The successive slots within the first set of slots are separated by guard intervals. The guard intervals and/or the first set of slots may be preconfigured, and known to both a first vehicle and a second vehicle within the group of vehicles. For example, a memory of the first vehicle and/or the second vehicle may include non-signaled information stored thereon, which is indicative of the guard intervals and/or the first set of slots.

In certain aspects, slots within a first set of slots are configured with a periodicity based on chirp transmissions periodicity within a frame. For example, the slots may be defined with the periodicity that is compatible with a chirp periodicity within a frame to ensure that all the chirp transmissions of the frame will initiate within some slot within the first set of slots.

In certain aspects, a chirp transmission can be initiated at any time within a slot of a first set of slots, but not within a guard interval (although the chirp transmission that started within the slot may remain active during a following guard interval).

In certain cases, the chirp transmission may carry on for multiple slots (e.g., consecutive slots). For example, the chirp transmission in the first frame transmitted in the first slot for a first duration may include one or more of the first set of slots. The chirp transmission in the second frame transmitted in the second slot for a second duration may include the one or more of the first set of slots.

In certain aspects, the guard intervals and the first set of slots are designed and configured so chirp transmissions from different vehicles of different groups (including the first group) initiated over different slots do not interfere with each other (even though they may partially overlap). In some cases, the first set of slots and the guard intervals are independent of FMCW parameters.

In certain aspects, the first vehicle and the second vehicle may belong to different groups (and are assigned different set of slots). A guard interval is positioned between slots to avoid a chirp transmission from the first vehicle appear to the second vehicle as starting in a later slot. This is because such an event (if it happens) may cause interference at the second vehicle. To address this issue, as illustrated in FIG. 11, the guard interval between the successive slots is more than a maximum propagation delay between the first vehicle and the second vehicle (e.g., the guard interval is greater than the maximum propagation delay between interferer vehicles, and both the first and the second vehicles are protected from inter-group interference in this manner).

In certain aspects, orthogonality among the first vehicle and the second vehicle (e.g., these first and second vehicles may belong to different groups) applies for all chirp transmissions in their frames, as the chirp transmissions are transmitted periodically. Accordingly, the chirp transmissions may always occupy different slots to avoid inter-group interference.

In certain aspects, chirp transmissions from the first vehicle and the second vehicle (e.g., these vehicles may belong to a same first group and assigned a same first set of slots) that are initiated within a same slot may interfere with each other (i.e., a chirp transmission from the first vehicle may generate ghost targets at the second vehicle and vice versa).

In certain aspects, the first vehicle and the second vehicle start their chirp transmissions at different times during a slot within the first set of slots for the first vehicle and the second vehicle. The first vehicle and the second vehicle may maintain a same relative chirp transmission offset for all slots within the first set of slots during a duration of a frame of the chirp transmissions.

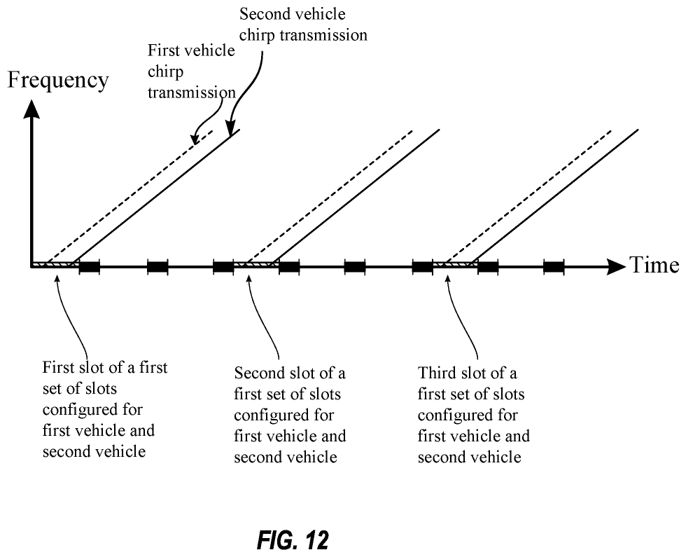

For example, as illustrated in FIG. 12, the first vehicle and the second vehicle start their chirp transmissions of a frame at different times during a first slot, a second slot, and a third slot within the first set of slots. The selection of the first slot, the second slot, and the third slot is such that these slots occur with a periodicity equal to the chirp transmission periodicity within the frame. As illustrated, the first vehicle and the second vehicle may maintain a same relative chirp transmission offset for all these slots within the duration of the frame of three chirp transmissions.

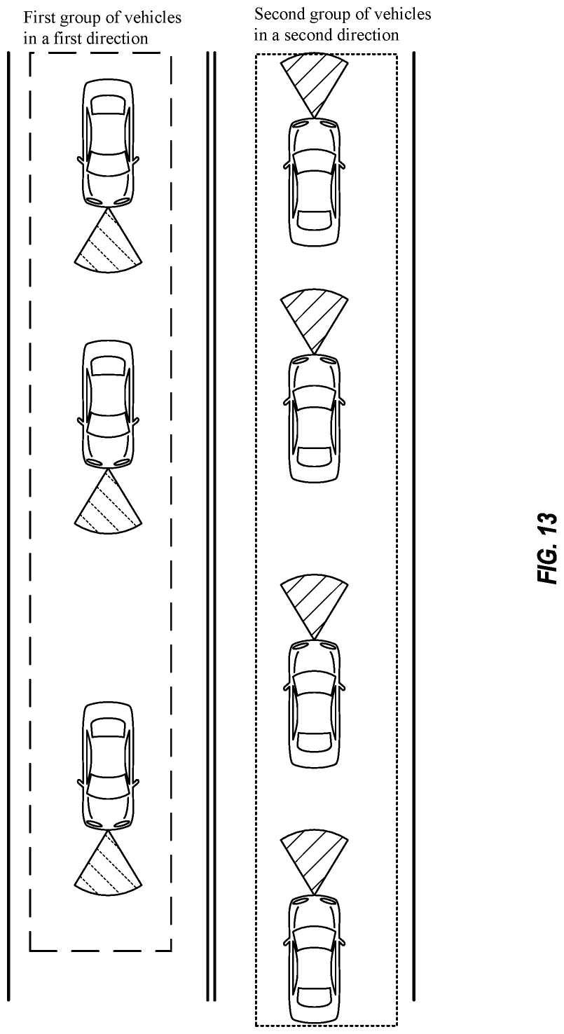

In certain aspects, a plurality of groups of vehicles may include the first group of vehicles and a second group of vehicles. The first group of vehicles may include at least the first vehicle and the second vehicle. The second group of vehicles may include at least a third vehicle and a fourth vehicle. In certain aspects, as illustrated in FIG. 13, vehicles (e.g., the first vehicle, the second vehicle, etc.) moving in a first direction are grouped as the first group of vehicles, and vehicles (e.g., a third vehicle, a fourth vehicle, etc.) moving in a second direction are grouped as the second group of vehicles. This grouping maybe performed based on operating information (e.g., a location, a field of view, etc.) associated with the vehicles. All vehicles in the first group may transmit their chirp transmissions within same slots allocated for the first group of vehicles. All vehicles in the second group may transmit their chirp transmissions within a different set of slots allocated for the second group of vehicles. This may guarantee no inter-group interference.

In certain aspects, chirp transmissions from front mounted radar devices of vehicles in a same direction do not directly interfere each other. Accordingly, there is no issue of having these vehicles (in a same group) transmitting over the same slots. However, there can still be intra-group interference due to reflections from target objects that are in a field of view of multiple vehicles.

As noted above, to reduce or eliminate the intra-group interference, vehicles of a same group (e.g., the first vehicle and the second vehicle) may apply a time delay offset prior to a start of a new frame (e.g., compared to a nominal delay that is applied between an end of a previous frame and a start of a new frame). The time delay offset is different among frames of the same vehicle and among vehicles (e.g., the time delay offset can be randomly selected).

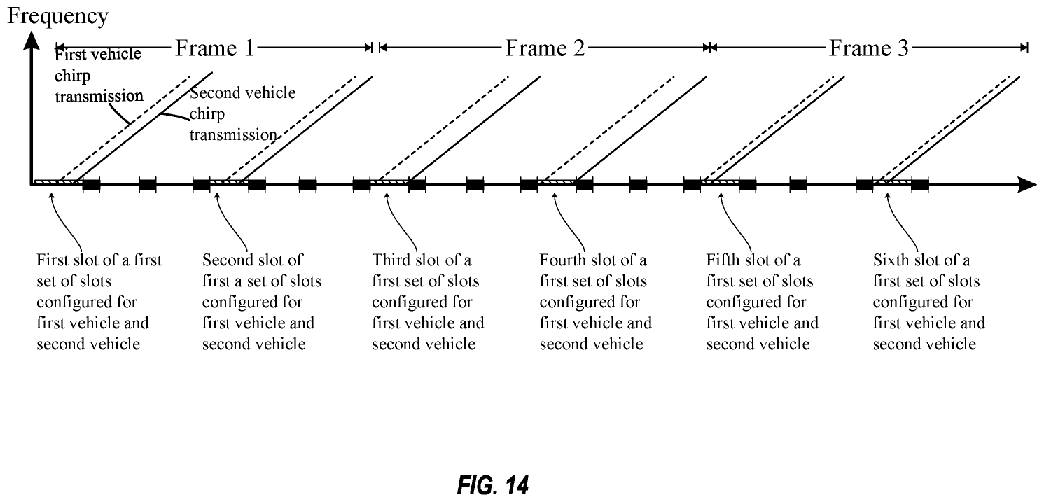

As illustrated in FIG. 14, each vehicle (e.g., the first vehicle, the second vehicle, etc.) applies a time delay offset (either positive or negative) to a start of a new frame. The application of the time delay offset shifts chirp transmissions of that frame within allocated slots (e.g., first to sixth slots) for the vehicle. As illustrated, a relative time delay offset between chirp transmission starting times of the first vehicle and the second vehicle is changing across a first frame (e.g., frame 1), a second frame (e.g., frame 2), and a third frame (e.g., frame 3). As noted above, the time delay offset is such that a start of a new frame occurs within a same slot as if no delay was applied (e.g., because otherwise a chirp transmission would occur over slots not assigned to the group).

In this example case, radar devices of the first vehicle and the second vehicle may apply different shifts/time delay offsets. As the two radar devices apply the different shifts, the radar devices may potentially generate ghost targets to each other. However, the ghost targets may appear as hopping among frames in a nonrealistic manner and filtered out as false alarms (e.g., by data-association and track-detection filters associated with processors of the vehicles).

In some cases, a data-association and track-detection filter may process time series of detections identified per frame. The data-association and track-detection filter may examine and process attributes of the detections (such as a range and a velocity) and group detections in successive frames as originating from a same target. The data-association and track-detection filter may detect multiple target objects/tracks. The data-association and track-detection filter may identify new tracks (corresponding to new detections with attributes not matching current tracks) and discard tracks (due to detections with the track attributes are no longer identified). The data-association and track-detection filter may discard detections altogether (without associating them to a track) when their attributes suggest they are noise artifacts.

In certain aspects, a plurality of groups of vehicles may include the first group of vehicles (e.g., the first vehicle, the second vehicle, etc.) and the second group of vehicles (e.g., the third vehicle, the fourth vehicle, etc.). As illustrated in FIG. 15, the first set of slots are configured for the first group of vehicles and a second set of slots are configured for the second group of vehicles. The second set of slots are different from the first set of slots. In some cases, the second set of slots may have different offsets relative to the first set of slots. In some cases, time delay offsets may be the same or different between the first group of vehicles and the second group of vehicles (e.g., starting point of chirp transmissions and distance between chirp transmissions). In some cases, one or more slots within the first set of slots and one or more slots within the second set of slots are separated by one or more guard intervals. In operation, the chirp transmissions during the first slot within the first set of slots are transmitted by the first vehicle and the second vehicle. The chirp transmissions during the first slot within the second set of slots are transmitted by the third vehicle and the fourth vehicle. In this example case, as the second set of slots have the different offsets relative to the first set of slots, this may enable reduction in the intra-group interference.

### Example Communications Device

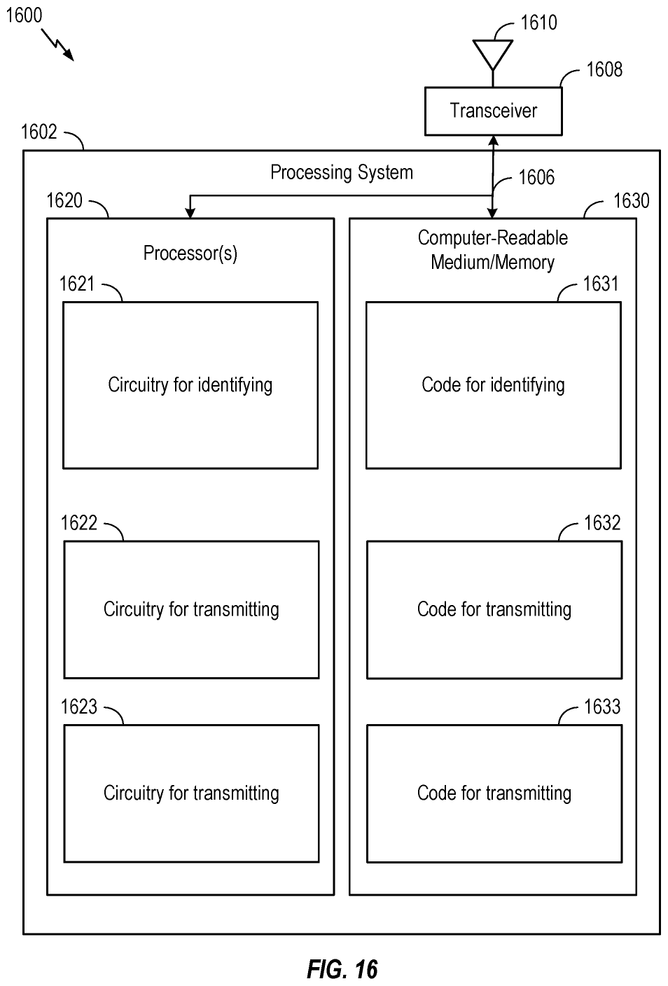

FIG. 16 depicts aspects of an example communications device 1600. In some aspects, communications device 1600 is a first apparatus, such as UE 104 described above with respect to FIGS. 1 and 3.

The communications device 1600 includes a processing system 1602 coupled to a transceiver 1608 (e.g., a transmitter and/or a receiver). The transceiver 1608 is configured to transmit and receive signals for the communications device 1600 via an antenna 1610, such as the various signals as described herein. The processing system 1602 may be configured to perform processing functions for the communications device 1600, including processing signals received and/or to be transmitted by the communications device 1600.

The processing system 1602 includes one or more processors 1620. In various aspects, the one or more processors 1620 may be representative of one or more of receive processor 358, transmit processor 364, TX MIMO processor 366, and/or controller/processor 380, as described with respect to FIG. 3. The one or more processors 1620 are coupled to a computer-readable medium/memory 1630 via a bus 1606. In certain aspects, the computer-readable medium/memory 1630 is configured to store instructions (e.g., computer-executable code) that when executed by the one or more processors 1620, cause the one or more processors 1620 to perform the operations 900 described with respect to FIG. 9, or any aspect related to it. Note that reference to a processor performing a function of communications device 1600 may include one or more processors performing that function of communications device 1600.

In the depicted example, computer-readable medium/memory 1630 stores code (e.g., executable instructions) for identifying 1631 comprising code for identifying a first set of slots configured for a first group of apparatuses including the first apparatus, code for transmitting 1632 comprising code for transmitting, according to a first time delay offset relative to a previous frame, a chirp transmission in a first frame during a first slot within the first set of slots, and code for transmitting 1633 comprising code for transmitting a chirp transmission in a second frame during a second slot within the first set of slots, according to a second time delay offset after the first frame, wherein the second time delay offset is different from the first time delay offset. Processing of the code 1631-1633 may cause the communications device 1600 to perform the operations 900 described with respect to FIG. 9, or any aspect related to it.

The one or more processors 1620 include circuitry configured to implement (e.g., execute) the code stored in the computer-readable medium/memory 1630, including circuitry for identifying 1621 comprising circuitry for identifying a first set of slots configured for a first group of apparatuses including the first apparatus, circuitry for transmitting 1622 comprising circuitry for transmitting, according to a first time delay offset relative to a previous frame, a chirp transmission in a first frame during a first slot within the first set of slots, and circuitry for transmitting 1623 comprising circuitry for transmitting a chirp transmission in a second frame during a second slot within the first set of slots, according to a second time delay offset after the first frame, wherein the second time delay offset is different from the first time delay offset. Processing with circuitry 1621-1623 may cause the communications device 1600 to perform the operations 900 described with respect to FIG. 9, or any aspect related to it.

Various components of the communications device 1600 may provide means for performing the operations 900 described with respect to FIG. 9, or any aspect related to it. For example, means for transmitting, sending or outputting for transmission may include the transceivers 354 and/or antenna(s) 352 of the UE 104 illustrated in FIG. 3 and/or transceiver 1608 and antenna 1610 of the communications device 1600 in FIG. 16. Means for receiving or obtaining may include the transceivers 354 and/or antenna(s) 352 of the UE 104 illustrated in FIG. 3 and/or transceiver 1608 and antenna 1610 of the communications device 1600 in FIG. 16.

### Example Clauses

Implementation examples are described in the following numbered clauses:

Clause 1: A method for wireless communications by a first apparatus, comprising: identifying a first set of slots configured for a first group of apparatuses including the first apparatus; transmitting, according to a first time delay offset relative to a previous frame, a chirp transmission in a first frame during a first slot within the first set of slots; and transmitting a chirp transmission in a second frame during a second slot within the first set of slots, according to a second time delay offset after the first frame, wherein the second time delay offset is different from the first time delay offset.

Clause 2: The method alone or in combination with the first clause, wherein the first group of apparatuses is associated with a common time reference.

Clause 3: The method alone or in combination with the first clause, wherein the first group of apparatuses is associated with a same set of frequency-modulated continuous wave (FMCW) parameters, and wherein the set of FMCW parameters comprises one or more of: a bandwidth, a carrier frequency, a chirp transmission duration; upchirp intervals; downchirp intervals; a number of chirp transmissions per frame; a chirp transmission period within a frame; a frame period; or a sampling frequency.

Clause 4: The method alone or in combination with the first clause, wherein the first set of slots represent partitions of time, and wherein successive slots within the first set of slots are separated by guard intervals.

Clause 5: The method alone or in combination with the fourth clause, wherein: a memory comprises non-signaled information stored thereon, and wherein the non-signaled information is indicative of the guard intervals and the first set of slots; and the guard intervals and the first set of slots correspond to each apparatus within the first group of apparatuses.

Clause 6: The method alone or in combination with the fourth clause, wherein a guard interval between the successive slots is more than a maximum propagation delay associated with the first group of apparatuses.

Clause 7: The method alone or in combination with the first clause, wherein slots within the first set of slots have a periodicity based on chirp transmission periodicity within each frame of a plurality of frames corresponding to the first group of apparatuses, wherein the plurality of frames comprise at least the first frame and the second frame.

Clause 8: The method alone or in combination with the first clause, wherein: the transmitting comprises transmitting the chirp transmission in a first plurality of non-sequential slots within the first set of slots, wherein the first plurality of non-sequential slots includes the first slot; and the transmitting comprises transmitting the chirp transmission in a second plurality of non-sequential slots within the first set of slots, wherein the second plurality of non-sequential slots includes the second slot.

Clause 9: The method alone or in combination with the fourth clause, wherein the guard intervals and the first set of slots are configured so chirp transmissions from different apparatuses of different groups comprising the first group of apparatuses initiated over different slots do not interfere with each other.

Clause 10: The method alone or in combination with the first clause, wherein the first group of apparatuses comprises a second apparatus, and further comprising starting chirp transmissions at different times during each slot within the first set of slots relative to start times of chip transmissions associated with the second apparatus during the slot.

Clause 11: The method alone or in combination with the tenth clause, further comprising maintaining a chirp transmission offset for all slots within the first set of slots during which the chirp transmissions are transmitted.

Clause 12: The method alone or in combination with the first clause, further comprising identifying the first group of apparatuses based on operating information associated with apparatuses within the first group of apparatuses, wherein the operating information comprises one or more of: location information, orientation information, movement information, or field of view information.

Clause 13: The method alone or in combination with the twelfth clause, wherein a memory comprises non-signaled information stored thereon, and wherein the non-signaled information is indicative of the first set of slots for the first group of apparatuses.

Clause 14: The method alone or in combination with the first clause, further comprising receiving an indication, from a network entity, indicating the first set of slots allocated for the first group of apparatuses.

Clause 15: The method alone or in combination with the first clause, further comprising randomly selecting the first time delay offset and the second time delay offset.

Clause 16: The method alone or in combination with the first clause, wherein a time delay offset between frames of apparatuses within the first group of apparatuses is different.

Clause 17: The method alone or in combination with the first clause, wherein the first time delay offset and the second time delay offset are restricted so one or more chirp transmissions of the first frame and the second frame fall within allocated slots within the first set of slots for the first group of apparatuses.

Clause 18: The method alone or in combination with the first clause, wherein the first time delay offset is a positive time delay offset or a negative time delay offset.

Clause 19: The method alone or in combination with the first clause, wherein the second time delay offset is a positive time delay offset or a negative time delay offset.

Clause 20: The method alone or in combination with the first clause, wherein: the first group of apparatuses corresponds to a plurality of groups of apparatuses, the plurality of groups of apparatuses comprises the first group of apparatuses and a second group of apparatuses, the first group of apparatuses comprises the first apparatus and a second apparatus, and the second group of apparatuses comprises a third apparatus and a fourth apparatus.

Clause 21: The method alone or in combination with the twentieth clause, wherein the first set of slots configured for the first group of apparatuses are different from a second set of slots configured for the second group of apparatuses.

Clause 22: The method alone or in combination with the twenty-first clause, wherein one or more slots within the first set of slots and one or more slots within the second set of slots are separated by one or more guard intervals.

Clause 23: The method alone or in combination with the twentieth clause, wherein: the chirp transmission in the first frame during the first slot within the first set of slots and the chirp transmission in the second frame during the second slot within the first set of slots correspond to the first apparatus; and a chirp transmission in a third frame during the first slot within the first set of slots and a chirp transmission in a fourth frame during the second slot within the first set of slots correspond to the second apparatus.

Clause 24: The method alone or in combination with the first clause, further comprising receiving a non-interfering chirp transmission from another apparatus of the first group of apparatuses.

Clause 27: An apparatus, comprising: a memory comprising executable instructions; and a processor configured to execute the executable instructions and cause the apparatus to perform a method in accordance with any one of Clauses 1-24.

Clause 28: An apparatus, comprising means for performing a method in accordance with any one of Clauses 1-24.

Clause 29: A non-transitory computer-readable medium comprising executable instructions that, when executed by a processor of an apparatus, cause the apparatus to perform a method in accordance with any one of Clauses 1-24.

Clause 30: A computer program product embodied on a computer-readable storage medium comprising code for performing a method in accordance with any one of Clauses 1-24.

### Additional Considerations

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A first apparatus for wireless communication, comprising:
a memory; and
at least one processor coupled to the memory, wherein the at least one processor is configured to:
identify a first set of slots configured for a first group of apparatuses including the first apparatus;
transmit, according to a first time delay offset relative to a previous frame, a chirp transmission in a first frame during a first slot within the first set of slots; and
transmit a chirp transmission in a second frame during a second slot within the first set of slots, according to a second time delay offset after the first frame, wherein the second time delay offset is different from the first time delay offset.

2. The first apparatus of claim 1, wherein the first group of apparatuses is associated with a common time reference.

3. The first apparatus of claim 1, wherein the first group of apparatuses is associated with a same set of frequency-modulated continuous wave (FMCW) parameters, and wherein the set of FMCW parameters comprises one or more of:
a bandwidth,
a carrier frequency,
a chirp transmission duration;
upchirp intervals;
downchirp intervals;
a number of chirp transmissions per frame;
a chirp transmission period within a frame;
a frame period; or
a sampling frequency.

4. The first apparatus of claim 1, wherein the first set of slots represent partitions of time, and wherein successive slots within the first set of slots are separated by guard intervals.

5. The first apparatus of claim 4, wherein:
the memory comprises non-signaled information stored thereon, and wherein the non-signaled information is indicative of the guard intervals and the first set of slots; and
the guard intervals and the first set of slots correspond to each apparatus within the first group of apparatuses.

6. The first apparatus of claim 4, wherein a guard interval between the successive slots is more than a maximum propagation delay associated with the first group of apparatuses.

7. The first apparatus of claim 1, wherein slots within the first set of slots have a periodicity based on chirp transmission periodicity within each frame of a plurality of frames corresponding to the first group of apparatuses, wherein the plurality of frames comprise at least the first frame and the second frame.

8. The first apparatus of claim 1, wherein:
to transmit the chirp transmission in the first frame in the first slot, the at least one processor is configured to transmit the chirp transmission in a first plurality of non-sequential slots within the first set of slots, wherein the first plurality of non-sequential slots includes the first slot; and
to transmit the chirp transmission in the second frame in the second slot, the at least one processor is configured to transmit the chirp transmission in a second plurality of non-sequential slots within the first set of slots, wherein the second plurality of non-sequential slots includes the second slot.

9. The first apparatus of claim 4, wherein the guard intervals and the first set of slots are configured so chirp transmissions from different apparatuses of different groups comprising the first group of apparatuses initiated over different slots do not interfere with each other.

10. The first apparatus of claim 1, wherein the first group of apparatuses comprises a second apparatus, and wherein the at least one processor is further configured to start chirp transmissions at different times during each slot within the first set of slots relative to start times of chip transmissions associated with the second apparatus during the slot.

11. The first apparatus of claim 10, wherein the at least one processor is configured to maintain a chirp transmission offset for all slots within the first set of slots during which the chirp transmissions are transmitted.

12. The first apparatus of claim 1, wherein the at least one processor is further configured to identify the first group of apparatuses based on operating information associated with apparatuses within the first group of apparatuses, wherein the operating information comprises one or more of: location information, orientation information, movement information, or field of view information.

13. The first apparatus of claim 12, wherein the memory comprises non-signaled information stored thereon, and wherein the non-signaled information is indicative of the first set of slots for the first group of apparatuses.

14. The first apparatus of claim 1, wherein the at least one processor is further configured to receive an indication, from a network entity, indicating the first set of slots allocated for the first group of apparatuses.

15. The first apparatus of claim 1, wherein the at least one processor is further configured to randomly select the first time delay offset and the second time delay offset.

16. The first apparatus of claim 1, wherein a time delay offset between frames of apparatuses within the first group of apparatuses is different.

17. The first apparatus of claim 1, wherein the first time delay offset and the second time delay offset are restricted so one or more chirp transmissions of the first frame and the second frame fall within allocated slots within the first set of slots for the first group of apparatuses.

18. The first apparatus of claim 1, wherein the first time delay offset is a positive time delay offset or a negative time delay offset.

19. The first apparatus of claim 1, wherein the second time delay offset is a positive time delay offset or a negative time delay offset.

20. The first apparatus of claim 1, wherein:
the first group of apparatuses corresponds to a plurality of groups of apparatuses, the plurality of groups of apparatuses comprises the first group of apparatuses and a second group of apparatuses,
the first group of apparatuses comprises the first apparatus and a second apparatus, and
the second group of apparatuses comprises a third apparatus and a fourth apparatus.

21. The first apparatus of claim 20, wherein the first set of slots configured for the first group of apparatuses are different from a second set of slots configured for the second group of apparatuses.

22. The first apparatus of claim 21, wherein one or more slots within the first set of slots and one or more slots within the second set of slots are separated by one or more guard intervals.

23. The first apparatus of claim 20, wherein:
the chirp transmission in the first frame during the first slot within the first set of slots and the chirp transmission in the second frame during the second slot within the first set of slots correspond to the first apparatus; and
a chirp transmission in a third frame during the first slot within the first set of slots and a chirp transmission in a fourth frame during the second slot within the first set of slots correspond to the second apparatus.

24. The first apparatus of claim 1, wherein the at least one processor is further configured to receive a non-interfering chirp transmission from another apparatus of the first group of apparatuses.

25. A method for wireless communication by a first apparatus, comprising:
identifying a first set of slots configured for a first group of apparatuses including the first apparatus;
transmitting, according to a first time delay offset relative to a previous frame, a chirp transmission in a first frame during a first slot within the first set of slots; and
transmitting a chirp transmission in a second frame during a second slot within the first set of slots, according to a second time delay offset after the first frame, wherein the second time delay offset is different from the first time delay offset.

26. The method of claim 25, wherein the first group of apparatuses is associated with a common time reference.

27. The method of claim 25, wherein the first group of apparatuses is associated with a same set of frequency-modulated continuous wave (FMCW) parameters, and wherein the set of FMCW parameters comprises one or more of:
a bandwidth,
a carrier frequency,
a chirp transmission duration;
upchirp intervals;
downchirp intervals;
a number of chirp transmissions per frame;
a chirp transmission period within a frame;
a frame period; or
a sampling frequency.

28. The method of claim 25, wherein the first set of slots represent partitions of time, and wherein successive slots within the first set of slots are separated by guard intervals.

29. The method of claim 25, wherein the first time delay offset and the second time delay offset are restricted so one or more chirp transmissions of the first frame and the second frame fall within allocated slots within the first set of slots for the first group of apparatuses.

30. The method of claim 25, wherein the first time delay offset is a positive time delay offset or a negative time delay offset.
